(19) United States
(12) Patent Application Publication
(10) Pub. No.: US 2017/0273498 A1
(43) Pub. Date: Sep. 28, 2017

(54) HOT AND COLD BEVERAGE DISPENSING APPARATUS

(71) Applicant: Vishnu Singh, Mountain View, CA (US)

(72) Inventor: Vishnu Singh, Mountain View, CA (US)

(21) Appl. No.: 15/079,326

(22) Filed: Mar. 24, 2016

(51) Int. Cl. A47J 31/41; A47J 31/46; A47J 31/56; A47J 31/44

(52) U.S. Cl. CPC A47J 31/41; A47J 31/4403; A47J 31/467; A47J 31/56

(57) ABSTRACT

A hot and cold beverage dispensing apparatus for dispensing a hot and a cold beverage separately includes a water storage tank, a hot water circuit, a cold water circuit, beverage extract holding chambers, nozzles, and a control system. The hot water circuit receives water from the water storage tank and heats the water. The cold water circuit is isolated from the hot water circuit and receives the water from the water storage tank. The water is recirculated multiple times to make the cold beverage. The beverage extract holding chambers receive either the heated water or the cold water to make the hot beverage or the cold beverage respectively. The nozzles dispense the hot or the cold beverage respectively based on a selection received by a control system. The control system actuates one-way valves to control the flow of the water based on the received selection.

### FIELD OF THE INVENTION

The invention disclosed herein generally relates to beverage making apparatuses. More specifically, the invention generally relates to the apparatuses, which provide a means of making and dispensing beverages, for example, tea, coffee, etc.

### BACKGROUND

Beverages such as tea and coffee have been a favorite drink of people across the world ever since its discovery and introduction in Asia and Africa. Instant tea or instant coffee refers to commercially prepared coffee or tea made by various methods, for example, freeze drying, etc. Conventionally, beverage dispensing apparatuses used instant coffee or tea powder to make and dispense hot coffee or tea. Similarly, separate apparatuses helped make cold coffee. A beverage dispensing apparatus capable of making and dispensing both hot and cold coffee is required. This enables a user to refrain from spending unnecessarily for more than one beverage dispensing apparatus.

Furthermore, in existing cold coffee making apparatuses, the time taken to make and dispense cold coffee is long. These types of beverages are no longer fresh at the time when they are dispensed because of the relatively long time taken. Moreover, coffee or tea sprinkled into cold water may not be uniformly mixed and the resultant beverage may end up being tasteless. A beverage making apparatus which makes thoroughly mixed and uniformly tasting beverages is required.

Hence, there is a long felt but unresolved need for a beverage dispensing apparatus which makes and dispenses both hot and cold beverages as required by a user. Furthermore, there is a need for a beverage making apparatus which makes thoroughly mixed beverages that have uniform taste.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The hot and cold beverage dispensing apparatus disclosed herein addresses the above mentioned needs for a beverage dispensing apparatus which makes and dispenses both hot and cold beverages as required by a user. Furthermore, the hot and cold beverage dispensing apparatus disclosed herein addresses the need for a beverage making apparatus which makes thoroughly mixed beverages that have uniform taste. A hot and cold beverage dispensing apparatus for dispensing a hot beverage and a cold beverage separately comprises a water storage tank, a hot water circuit, a cold water circuit, one or more beverage extract holding chambers, at least two nozzles, and a control system. The water storage tank stores water. The hot water circuit is in fluid communication with the water storage tank and receives the water from the water storage tank and heats the water. The heated water is used to make the hot beverage.

The cold water circuit is in fluid communication with the water storage tank and isolated from the hot water circuit. The cold water circuit receives the water from the water storage tank and the water is recirculated multiple times to make the cold beverage. The beverage extract holding chambers are in fluid communication with the hot water circuit and the cold water circuit and receive either the heated water from the hot water circuit or the water from the cold water circuit to make the hot beverage or the cold beverage respectively. The nozzles are in fluid communication with the hot water circuit and the cold water circuit for dispensing the hot beverage and the cold beverage respectively based on a selection of a beverage received by the control system. The control system receives the selection of the beverage and is configured to actuate multiple one-way valves to control the flow of the water from the water storage tank to the nozzles via the hot water circuit and the cold water circuit.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a schematic diagram of a hot and cold beverage dispensing apparatus.

FIG. 2 exemplarily illustrates a cut away sectional view of a hot and cold beverage dispensing apparatus.

FIG. 3 exemplarily illustrates a perspective view of a hot and cold beverage dispensing apparatus.

### DETAILED DESCRIPTION OF THE INVENTION

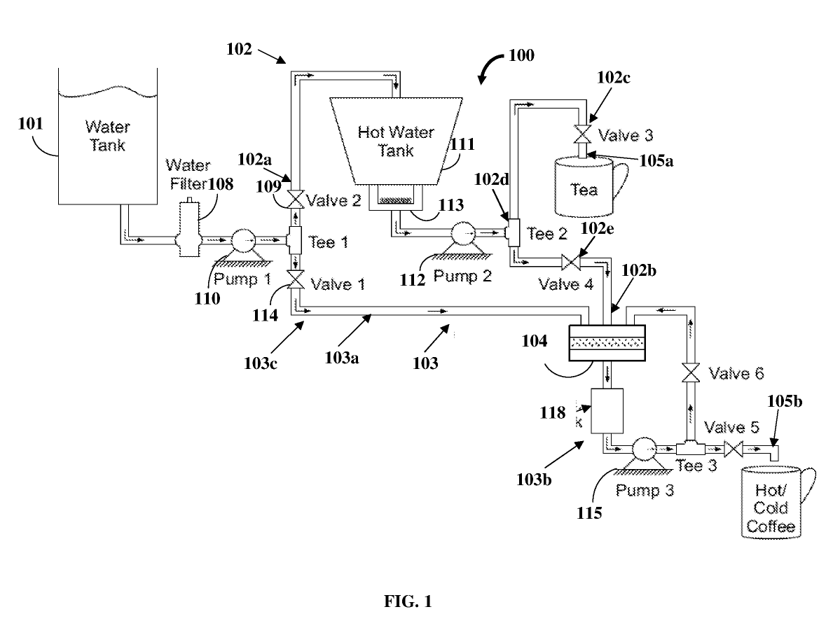

FIG. 1 exemplarily illustrates a schematic diagram of a hot and cold beverage dispensing apparatus 100. The hot and cold beverage dispensing apparatus 100 disclosed herein comprises a water storage tank 101, a hot water circuit 102, a cold water circuit 103, one or more beverage extract holding chambers 104, at least two nozzles 105, and a control system 106 exemplarily illustrated in FIG. 4. The water storage tank 101 is used for storing water for all functions of the hot and cold beverage dispensing apparatus 100. The water storage tank 101 is removably attached to a housing 107, which encloses the hot and cold beverage dispensing apparatus 100 entirely. The water storage tank 101 is filled with water by removing the water storage tank 101 from the hot and cold beverage dispensing apparatus 100 and filling it from a water source, for example, a water dispenser, a tap, etc. Additionally, the water storage tank 101 may be filled with water even when the water storage tank 101 is attached to the housing of the hot and cold beverage dispensing apparatus 100. Furthermore, the hot and cold beverage dispensing apparatus 100 also optionally comprises a filter 108 in fluid communication with the water storage tank 101. The filter 108 removes impurities from water by means of, for example, a fine physical barrier, a chemical process, a biological process, etc.

Additionally, filters use sieving, adsorption, ion exchanges, biological metabolite transfer, etc., to filter the water. Some filters use more than one process to filter the water. In an embodiment, the water from the water storage tank 101 flows to the filter 108 and the filter 108 filters the water received from the water storage tank 101. In places where the quality of water is good, the filter 108 is optional, whereas in areas with poor water quality the filter 108 is required. The filter 108 is replaceable and is replaced based on various criteria, for example, water quality, frequency of usage of the filter 108, etc. A first end 102a of the hot water circuit 102 is in fluid communication with the water storage tank 101 and receives the water from the water storage tank 101 when a unidirectional valve 109 opens to allow access to the water. The opening and closing of the unidirectional valve 109 is triggered by the control system 106 exemplarily illustrated in FIG. 4. The unidirectional valve 109 used is, for example, a solenoid valve. A solenoid valve is an electromechanically operated valve.

A solenoid valve is controlled by an electric current through a solenoid. The supply and timing of the electric current is determined by the control system 106 exemplarily illustrated in FIG. 4. The hot and cold beverage dispensing apparatus 100 also comprises a first pump 110 in fluid communication with the water storage tank 101. The first pump 110 draws water from the water storage tank 101 and pumps the water to either the hot water circuit 102 or the cold water circuit 103 as determined by the control system 106. The hot water circuit 102 comprises a hot water storage tank 111 and a second pump 112. In an embodiment, the hot water storage tank 111 is, for example, a sturdy, stainless steel structure with a heating element 113 built into the hot water storage tank 111.The heating element 113 is, for example, a coiled wire, similar to the filament of a light bulb or the heating element in an electric toaster which gets hot when electricity is run through it. In an embodiment, the heating element 113 is embedded in plaster to make it more rugged for heating the water. The second pump 112 is in fluid communication with the hot water storage tank 111 and pumps the heated water through a tee 102d, to a unidirectional valve 102c which can then be dispensed through the nozzle 105a. The second pump 112 pumps the heated water through a unidirectional valve 102e of the hot water circuit 102 and supplies the heated water to the beverage extract holding chambers 104.

The beverage extract holding chambers 104 may hold finely ground or freeze dried beverages, for example, instant coffee or tea. In an embodiment, sugar, milk powder, cocoa, or other beverages may also be mixed in various ratios and held by the beverage extract holding chambers 104. The cold water circuit 103 is in fluid communication with the water storage tank 101 and isolated from the hot water circuit 102. A unidirectional valve 114 opens and the water from the water storage tank 101 is sent to the beverage extract holding chambers 104. In hot water, the finely ground beverage extracts easily mix and have a uniform taste. However, in cold water, the beverage extracts do not mix uniformly at first. Hence, the water is recirculated multiple times to make the cold beverage uniformly mixed. The cold water circuit 103 comprises a conduit 103a and a recirculation circuit 103b. The conduit 103a is in fluid communication with the first pump 110 and receives the water from the water storage tank 101. The conduit 103a transfers the water from a first end 103c of the cold water circuit 103 to the beverage extract holding chambers 104. The recirculation circuit 103b is in fluid communication with the beverage extract holding chambers 104 to recirculate the cold beverage multiple times through the one or more beverage extract holding chambers 104. The recirculation circuit 103b comprises a third pump 115 for recirculating and supplying the cold beverage via the nozzle 105b.

The beverage extract holding chambers 104 are in fluid communication with the hot water circuit 102 and the cold water circuit 103. The beverage extract holding chambers 104 receive either the heated water from the hot water circuit 102 or the water from the cold water circuit 103 to make the hot beverage or the cold beverage respectively. The nozzles 105a and 105b are in fluid communication with the hot water circuit 102 and the cold water circuit 103 and dispense the hot beverage and the cold beverage respectively based on a selection received by the control system 106 as disclosed in the detailed description of FIG. 4.

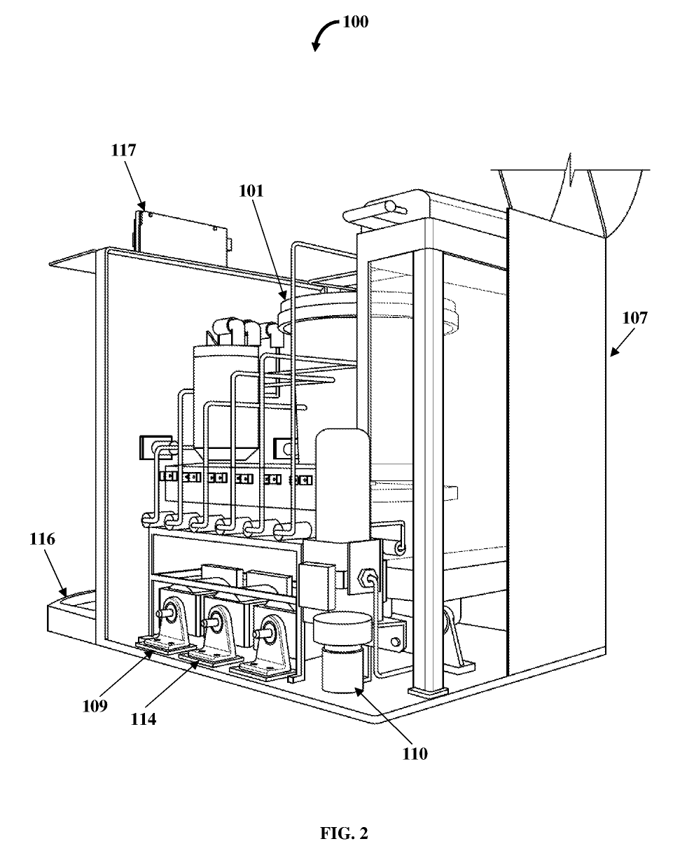

FIG. 2 exemplarily illustrates a cut away sectional view of a hot and cold beverage dispensing apparatus 100. As disclosed in the detailed description of FIG. 1, the hot and cold beverage dispensing apparatus 100 comprises a water storage tank 101. The hot and cold beverage dispensing apparatus 100 is enclosed in a housing 107. The first pump 110 is positioned proximal to the water storage tank 101. Unidirectional valves 109 and 114 are actuated by a control system exemplarily illustrated in FIG. 4. The unidirectional valves 109 and 114 are, for example, solenoid valves. The unidirectional valves 109 and 114 shut off or open depending on an electric current supplied to the unidirectional valves 109 and 114 and thus control the flow of water in the hot and cold beverage dispensing apparatus 100. In an embodiment, coffee cups are placed on a tray 116, which extends from the housing 107 of the hot and cold beverage dispensing apparatus 100. In an embodiment, a user interface 117 is provided for a user to make selections. In an embodiment, the user interface 117 is, for example, the LCD Keypad shield. The LCD Keypad shield is developed for Arduino® compatible boards of Arduino, LLC, to provide a user-friendly interface that allows users to, for example, go through the menu, make selections etc.

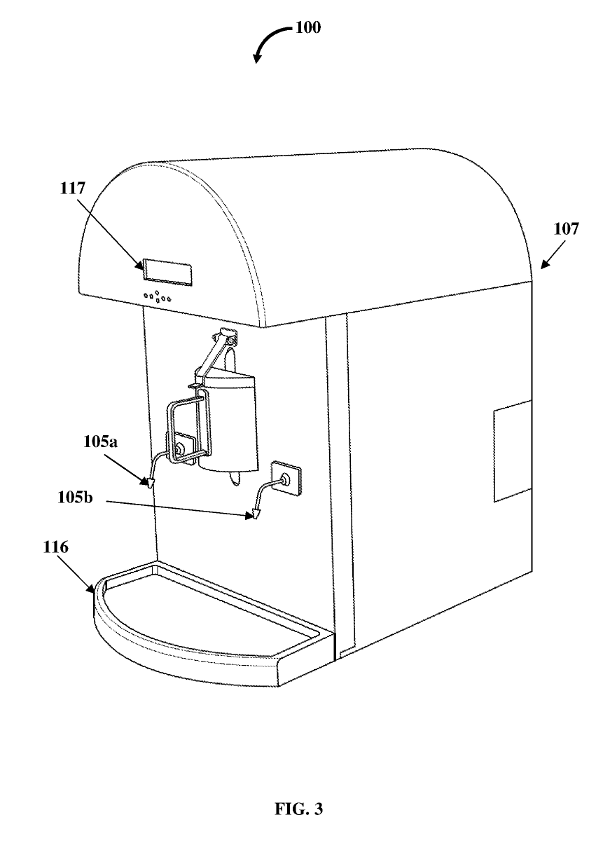

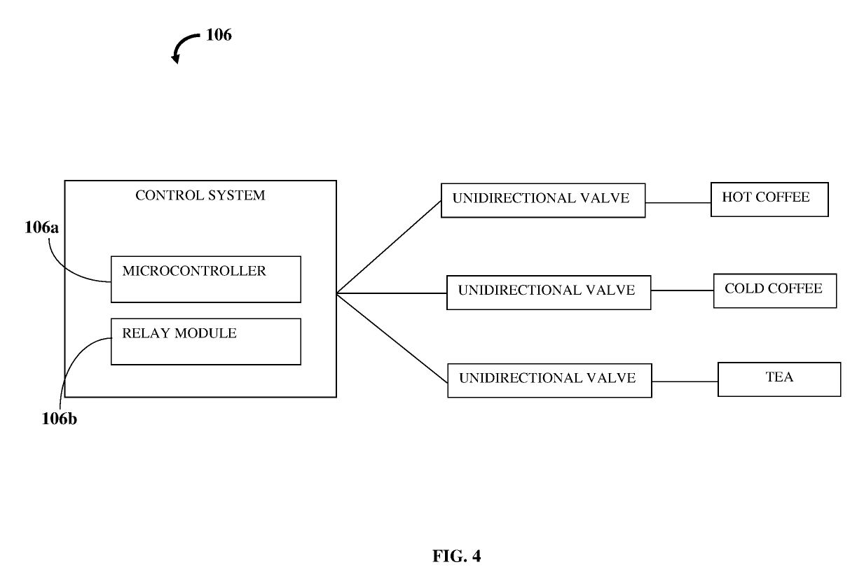

FIG. 3 exemplarily illustrates a perspective view of a hot and cold beverage dispensing apparatus 100. In an embodiment, the hot and cold beverage dispensing apparatus 100 is enclosed in a housing 107. The housing 107 prevents the interior of the hot and cold beverage dispensing apparatus 100 from being infested with insects, dirt, other unwanted objects, etc., which could affect the quality of the water running through the hot and cold beverage dispensing apparatus 100, and the efficient operation of the hot and cold beverage dispensing apparatus 100. In an embodiment, the hot and cold beverage dispensing apparatus 100 is provided with two nozzles 105a and 105b. In an embodiment, one nozzle 105a supplies hot water. The second nozzle 105b supplies a cold beverage, for example, cold coffee, or a hot beverage, for example hot coffee, or cocoa. In an embodiment, coffee or tea cups are placed on a tray 116 and positioned directly underneath the nozzles 105 to receive coffee or tea. In an embodiment, a user interface 117 is provided for a user to make selections. In an embodiment, the user interface 117 is, for example, the LCD Keypad shield. The LCD Keypad shield is developed for Arduino® compatible boards of Arduino, LLC, to provide a user-friendly interface that allows users to, for example, go through the menu, make selections etc. The LCD Keypad shield comprises a 16×2 white character blue backlit LCD. The keypad consists of five keys, for example, select, up, right, down, left, etc. To save the digital I/O pins, the keypad interface uses only one ADC channel. The key value is read through a 5 stage voltage divider. LCD Arduino.

FIG. 4 exemplarily illustrates a control system 106 of a hot and cold beverage dispensing apparatus 100. The control system 106 comprises a microcontroller 106a and a relay module 106b. The microcontroller 106a processes a selection provided by a user via the user interface 117 as exemplarily illustrated in FIGS. 2-3. In an embodiment, the microcontroller 106a used is the Mega 2560. The Mega 2560 is a microcontroller board based on the ATmega2560. The Mega 2560 has 54 digital input/output pins (of which 15 can be used as PWM outputs), 16 analog inputs, 4 UARTs (hardware serial ports), a 16 MHz crystal oscillator, a USB connection, a power jack, an ICSP header, and a reset button. The Mega 2560 supports the microcontroller 106a and connects to a computer with a USB cable or power it with an AC-to-DC adapter or battery to get started. The Mega 2560 board is compatible with most shields designed for the Uno and the former boards Duemilanove or Diecimila. The control system 106 receives the selection and is configured to actuate multiple unidirectional valves to control the flow of the water from the water storage tank 101 to the nozzles 105a and 105b via the hot water circuit 102 and the cold water circuit 103 as exemplarily illustrated in FIG. 1.

The microcontroller 106a is configured to execute the computer program instructions defined by the control system 106. The microcontroller 106a refers to any one or more microprocessors, central processor (CPU) devices, finite state machines, computers, processors, digital signal processors, logic, a logic device, an user circuit, an application specific integrated circuit (ASIC), a field-programmable gate array (FPGA), a chip, etc., or any combination thereof, capable of executing computer programs or a series of commands, instructions, or state transitions. In an embodiment, the microcontroller 106a is implemented as a processor set comprising, for example, a programmed microprocessor and a math or graphics co-processor. The microcontroller 106a is selected, for example, from the Intel® processors such as the Itanium® microprocessor or the Pentium® processors, Advanced Micro Devices (AMD®) processors such as the Athlon® processor, UltraSPARC® processors, microSPARC® processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The control system 106 disclosed herein is not limited to employing a microcontroller 106a. In an embodiment, the control system 106 employs a controller or a microcontroller 106a. The microcontroller 106a uses and executes the relay module 106b to actuate the unidirectional valves of the hot and cold beverage dispensing apparatus 100.

The first pump 110 draws the water from the water storage tank 101 and pumps the water to a tee. The tee divides the flow of water into the hot water circuit 102 and the cold water circuit 103. Consider the scenario in which a user wishes to drink hot coffee, the microcontroller 106a receives a selection and uses the relay module 106b to actuate the unidirectional valve 109. Simultaneously the unidirectional valve 114 is closed. Since the unidirectional valve 109 is opened the water pumped by the first pump 110 flows to the hot water storage tank 111. The microcontroller 106b actuates the heating element 113 and heats the water to a temperature of about 200° F. as exemplarily illustrated in FIG. 1. The heated water flows to the beverage extract holding chamber 104. The hot water has a high pressure supplied by the second pump 112. The hot water falls freely to the circulation tank 118. After circulation tank 118 is filled hot coffee is dispensed by the nozzles 105b of the hot and cold beverage dispensing apparatus 100.

Alternatively, if a user wishes to drink cold coffee, the microcontroller 106a directs the unidirectional valve 109 to be closed. Simultaneously, the unidirectional valve 114 is open. In this scenario, the water flows through the conduit 103a and flows to the beverage extract holding chamber 104. The water has a high pressure supplied by the first pump 110. The water falls freely to the circulation tank 118. After circulation tank 118 is filled the water is recirculated multiple times to the beverage extract holding chamber 104. After recirculation is finished, the cold brewed coffee flows through a unidirectional valve directly to a cup via the nozzle 105b as exemplarily illustrated in FIG. 1. In an embodiment, the microcontroller 106a of the control system 106 is used to pre-select the volume of either a hot beverage or a cold beverage dispensed by the nozzles 105a and 105b of the hot and cold beverage dispensing apparatus 100. In an embodiment, the optional volumes are, for example, 8 ounces, 12 ounces, 16 ounces, etc.

The foregoing examples have been provided merely for the purpose of explanation and are in no way to be construed as limiting of the hot and cold beverage dispensing apparatus 100, disclosed herein. While the hot and cold beverage dispensing apparatus 100 has been described with reference to various embodiments, it is understood that the words, which have been used herein, are words of description and illustration, rather than words of limitation. Further, although the hot and cold beverage dispensing apparatus 100 has been described herein with reference to particular means, materials, and embodiments, the hot and cold beverage dispensing apparatus 100 is not intended to be limited to the particulars disclosed herein; rather, the hot and cold beverage dispensing apparatus 100 extends to all functionally equivalent structures, methods and uses, such as are within the scope of the appended claims. Those skilled in the art, having the benefit of the teachings of this specification, may effect numerous modifications thereto and changes may be made without departing from the scope and spirit of the hot and cold beverage dispensing apparatus 100 disclosed herein in their aspect.

What is claimed is:

1. A hot and cold beverage dispensing apparatus for dispensing a hot beverage and a cold beverage separately, the hot and cold beverage dispensing apparatus comprising:
a water storage tank for storing water;
a hot water circuit in fluid communication with the water storage tank for receiving the water from the water storage tank and heating the water, wherein the heated water is used to make the hot beverage;
a cold water circuit in fluid communication with the water storage tank and isolated from the hot water circuit for receiving the water from the water storage tank, wherein the water is recirculated one or more times to make the cold beverage;
one or more beverage extract holding chambers in fluid communication with the hot water circuit and the cold water circuit for receiving one of the heated water from the hot water circuit and the water from the cold water circuit to make one of the hot beverage and the cold beverage respectively;
at least two nozzles in fluid communication with the hot water circuit and the cold water circuit for dispensing the hot beverage and the cold beverage respectively based on a selection received by a control system; and
the control system for receiving the selection and configured to actuate a plurality of unidirectional valves to control the flow of the water from the water storage tank to the at least two nozzles via the hot water circuit and the cold water circuit.

2. The hot and cold beverage dispensing apparatus of claim 1, further comprising a filter in fluid communication with the water storage tank, wherein the filter filters the water received from the water storage tank.

3. The hot and cold beverage dispensing apparatus of claim 1, further comprising a first pump in fluid communication with the water storage tank for pumping the water from the water storage tank to one of the hot water circuit and the cold water circuit.

4. The hot and cold beverage dispensing apparatus of claim 1, wherein the hot water circuit comprises:
a hot water storage tank in fluid communication with a first pump for receiving the water from the water storage tank, wherein the hot water storage tank comprises a heating element for heating the water; and
a second pump in fluid communication with the hot water storage tank for pumping the heated water to the one or more beverage extract holding chambers.

5. The hot and cold beverage dispensing apparatus of claim 1, wherein the cold water circuit comprises:
a conduit in fluid communication with a first pump, wherein the conduit receives the water from the water storage tank, and wherein the conduit transfers the water to the one or more beverage extract holding chambers; and
a recirculation circuit in fluid communication with the one or more beverage extract holding chambers to recirculate a the cold beverage multiple times through the one or more beverage extract holding chambers, wherein the recirculation circuit comprises a third pump for recirculating and supplying one of the hot beverage and the cold beverage via one of the at least two nozzles.

6. The hot and cold beverage dispensing apparatus of claim 1, wherein a controller of the control system is used to pre-select the volume of one of a hot beverage and a cold beverage dispensed by the at least two nozzles of the hot and cold beverage dispensing apparatus.
